(19) United States
(12) Patent Application Publication
(10) Pub. No.: US 2014/0136476 A1
(43) Pub. Date: May 15, 2014

(54) ELECTRONIC DOCUMENT SUPPLYING SYSTEM AND METHOD FOR ANALYZING READING BEHAVIOR

(71) Applicant: INSTITUTE FOR INFORMATION INDUSTRY, Taipei (TW)

(72) Inventor: Yen-Hung KUO, Taipei City (TW)

(73) Assignee: INSTITUTE FOR INFORMATION INDUSTRY, TAIPEI (TW)

(21) Appl. No.: 13/711,545

(22) Filed: Dec. 11, 2012

(30) Foreign Application Priority Data
Nov. 14, 2012 (TW) 101142398

(51) Int. Cl. G06F 17/30

(52) U.S. Cl. CPC G06F 17/30312
USPC 707/609; 707/748

(57) ABSTRACT

An electronic document supplying system includes a host server device and an analysis server device. The host server device includes an electronic document supplier and a first processer, and the analysis server device includes a database, an analyzer, and a second processer. The first processer analyzes a reading behavior corresponding to one of documents to generate a corresponding reading content weight and transfer the reading content weight to the electronic document supplier. The database collects the reading content weight generated by the reading behaviors of the electronic documents. The to analyzer analyzes the reading content weight to generate corresponding analysis data. The second processer marks the electronic documents based on the analysis data and transfer the marked electronic documents to the database for storing. The electronic document supplier receives the marked electronic documents from the database and supplies the marked electronic documents.

### RELATED APPLICATIONS

This application claims priority to Taiwan Application Serial Number 101142398, filed Nov. 14, 2012, which is herein incorporated by reference.

### BACKGROUND

1. Field of Invention

The embodiment of the present invention relates generally to a system and method, more particularly, to an electronic document supplying system and a method for analyzing reading behavior.

2. Description of Related Art

Due to the increasing of environmental awareness, the way in which people read has been changed from reading a traditional book to an electronic document so as to reduce usage quantity of papers such that a cut down quantity of trees, which is used as materials of papers, can be decreased.

In the age of information explosion, the information people need to read also increases correspondingly. However, time is limited; therefore, how to read Information from the electronic document as many as possible in limited time becomes a key issue.

### SUMMARY

An electronic document supplying system and a method for analyzing reading behavior are provided such that people can read information from electronic documents as many as possible in limited time.

One aspect of the embodiment of the present invention is to provide an electronic document supplying system. The electronic document supplying system comprises a host sewer device, and an analysis server device. Furthermore, the host server device comprises an electronic document supplier, and a first processer, and the analysis server device comprises a database, an analyzer, and a second processor.

With respect to the operation, the electronic document supplier is operable to provide a plurality of electronic documents. The first processer is operable to analyze a reading behavior corresponding to one of the electronic documents to correspondingly generate a reading content weight, wherein the first processer is operable to transfer the reading content weight to the electronic document supplier. The database is operable to collect the reading content weights generated from the reading behaviors of the electronic documents. The analyzer is operable to analyze the reading content weights to generate a plurality of corresponding analyze data. The second processer is operable to mark the electronic documents according to the analyze data to correspondingly generate a plurality of marked electronic documents and transfer the marked electronic documents to the database for storing. The electronic document supplier is operable to receive the marked electronic documents from the database to provide the marked electronic documents.

In one embodiment of the present invention, a paragraph is used as a unit of the reading behavior.

In another embodiment of the present invention, the reading behavior is a reading trajectory which is formed by reading through paragraph to paragraph respectively.

In yet another embodiment of the present invention, the reading behavior comprises one of a group consisting of a sequential reading, a backtracking reading, a keyword spotting reading, a forward checking reading, a link clicking reading, and a selective reading.

In still another embodiment of the present invention, a mark of the marked electronic document comprises one of a group of a boldface mark, an italic mark, an underline mark, and a highlighted mark.

In another aspect of the embodiment of the present invention, a method for analyzing reading behavior is provided. The method for analyzing reading behavior comprises the steps of:

providing a plurality of electronic documents;

analyzing a reading behavior corresponding to one of the electronic documents to correspondingly generate a reading content weight;

collecting the reading content weights generated from the reading behaviors of the electronic documents;

analyzing the reading content weights to generate a plurality corresponding analyze data;

marking the electronic documents according to the analyze data to correspondingly generate a plurality of marked electronic documents; and

providing the marked electronic documents.

In one embodiment of the present invention, a paragraph is used as unit of the reading behavior.

In another embodiment of the present invention, the reading behavior comprises the step of reading through paragraph to paragraph respectively.

In yet another embodiment of the present invention, the reading behavior comprises one of a group consisting of a sequential reading, a backtracking reading, a keyword spotting reading, a forward checking reading, a link clicking reading, and a selective reading.

In still another embodiment of the present invention, a mark of the marked electronic document comprises one of a group of a boldface mark, an italic mark, an underline mark, and a highlighted mark.

As a result, the embodiments of the present invention provide an electronic document supplying system and a method for analyzing reading behavior, which is used to mark electronic documents according to reading behaviors such that people can read information from the electronic documents as any as possible in limited time.

### BRIEF DESCRIPTION OF THE DRAWINGS

The invention can be more fully understood by reading the following detailed description of the embodiments, with reference made to the accompanying drawings as follows:

FIG. 1 schematically shows a diagram of reading behaviors of electronic documents according to embodiments of the present invention.

FIG. 2 schematically shows a block diagram of an electronic document supplying system according to embodiments of the present invention.

FIG. 3 schematically shows a diagram of a sequential reading behavior according to embodiments of the present invention.

FIG. 4 schematically shows a diagram of a backtracking reading behavior according to embodiments of the present invention.

FIG. 5 schematically shows a diagram of a keyword spotting reading behavior according to embodiments of the present invention.

FIG. 6 schematically shows a diagram of a forward checking reading behavior according to embodiments of the present invention.

FIG. 7 schematically shows a diagram of a link clicking reading behavior according to embodiments of the present invention.

FIG. 8 schematically shows a diagram of a selective reading behavior according to embodiments of the present invention.

FIG. 9 schematically shows a flow diagram of a method for analyzing reading behavior according to embodiments of the present invention.

### DETAILED DESCRIPTION

The present invention is more particularly described in the following to examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. The use of examples anywhere in this specification including examples of any terms discussed herein, is illustrative only, and in no way limits the scope and meaning of the invention or of any exemplified term. Likewise, the invention is not limited to various embodiments given in this specification.

As used herein, “around,” “about” or “approximately” shall generally mean within 20 percent, preferably within 10 percent, and more preferably within 5 percent of a given value or range. Numerical quantities given herein are approximate, meaning that the term “around,” “about” or “approximately” can be inferred if not expressly stated.

As used herein, the terms “comprising,” “including,” “having,” “containing,” “involving,” and the like are to be understood to be open-ended, i.e., to mean including but not limited to.

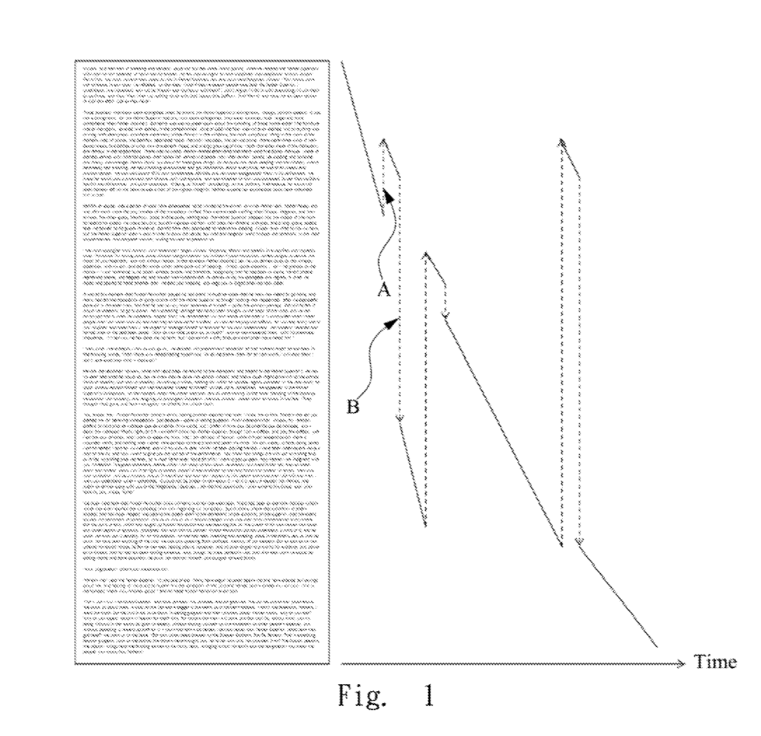

FIG. 1 schematically shows a diagram of reading behaviors of electronic documents according to embodiments of the present invention. The line as shown in FIG. 1 is a reading trajectory of a reader. When reading, for example, readers may go back to read one of the paragraphs (the reading trajectory marked by A) or go to next paragraph (the reading trajectory marked by B) according to importance of electronic documents. The present invention is operable to analyze the above-mentioned reading behavior for marking the electronic documents such that the readers know the importance of paragraphs of electronic documents; and accordingly, the goal of making people read information from electronic documents as many as possible in limited time can be achieved.

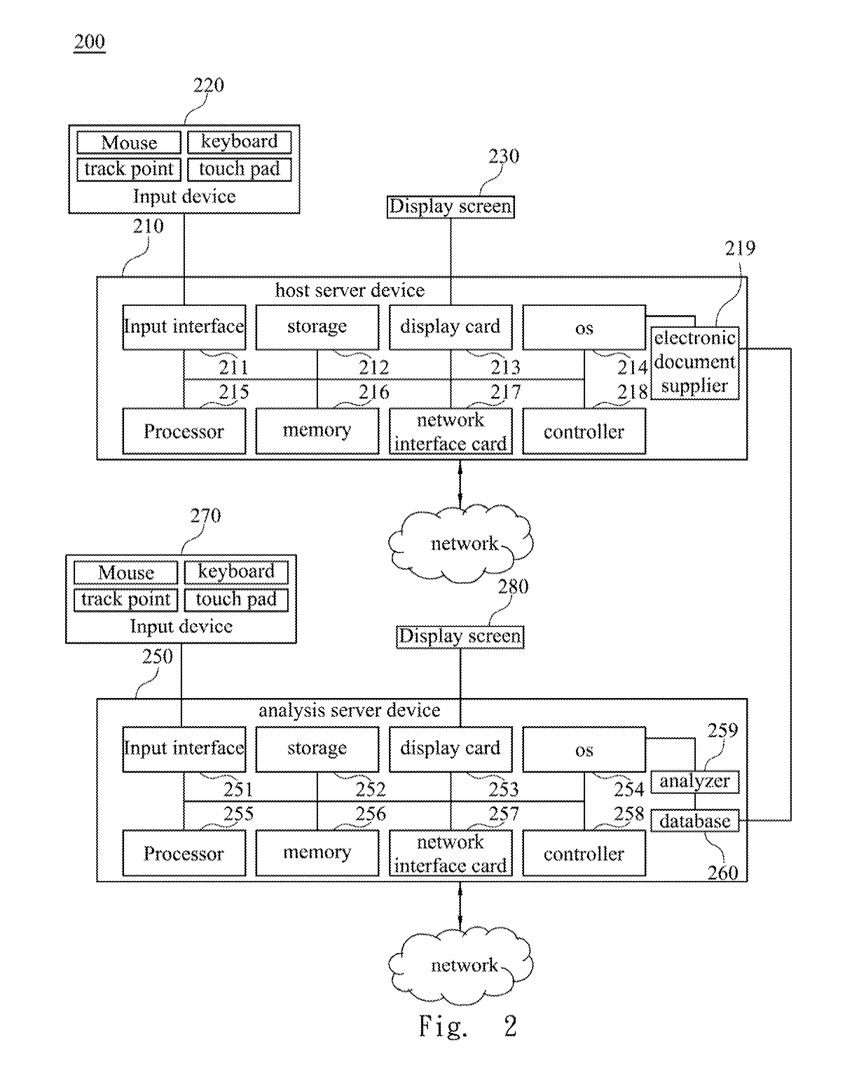

The main concept of the present invention is disclosed in description of FIG. 2. FIG. 2 schematically shows a block diagram of an electronic document supplying system according to embodiments of the present invention. As shown in FIG. 2, an electronic document supplying system 200 mainly comprises a host server device 210, and an analysis server device 250. Other devices such as input devices 220, 270 and display screens 230, 280 are operable to control related devices of a host server device 210, and an analysis server device 250.

The host server device 210 comprises an input interface 211 a storage 212, a display card 213, an operating system (os) 214 (for example, the operating system 214 can be stored in the storage 212), a processor 215, a memory 216, a network interface card 217, a controller 218, and an electronic document supplier 219. The above-mentioned devices are electrically connected to each other. In addition, the analysis server device 250 comprises an input interface 251, a storage 252, a display card 253, an operating system (os) 254 (for example, the operating system 254 can be stored in the storage 252), a processor 255, a memory 256, a network interface card 257, a controller 258, an analyzer 259, and a database 260. The above-mentioned devices are electrically connected to each other. However, the scope of the present invention is not intended to be limited to the elements and the connection of the above-mentioned device and the above-mentioned device is merely used to describe one of implementations of the present invention.

With respect to the operation of the host server device 210, the electronic document supplier 219 is operable to provide a plurality of electronic documents. The processor 215 (or the controller 218) is operable to analyze a reading behavior corresponding to one of the electronic documents to correspondingly generate a reading content weight. The processor 215 is operable to transfer the reading content weight to the electronic document supplier 219.

For example, the reading behavior can be a reading trajectory which is formed by reading through paragraph to paragraph respectively. The reading trajectory can be referred to the description of FIG. 1. It is noted that a paragraph is used as a unit of the reading behavior. Specifically, the reading trajectory can be a trajectory generated by a sequential reading, a backtracking reading, a keyword spotting reading, a forward checking reading, a link clicking reading, or a selective reading. The reading content weight is corresponding to importance of a paragraph for an electrical document. When the importance of the paragraph for the electrical document is higher, the reading content weight is correspondingly higher. The reading content weight can be generated by the processor 215 analyzing reading trajectories for electrical documents.

With respect to the operation, of the analysis server device 250, the database 260 is operable to collect the reading content weights generated from the reading behaviors of the electronic documents. The analyzer 259 is operable to analyze the reading content weights to generate a plurality of corresponding analyze data. The processor 255 the controller 258) is operable to mark the electronic documents according to the analyze data to correspondingly generate a plurality of marked electronic documents and transfer the marked electronic documents to the database 260 for storing.

For example, the database 260 is operable to collect reading content weights of all read electronic documents and transfer the reading content weights to the analyzer 259 for analyzing so as to generate analyze data. The processor 255 can mark the corresponding electronic documents according to the analyze data. Specifically, a mark of the marked electronic document can be a boldface mark, an italic mark, an underline mark, or a highlighted mark. The paragraph of the electronic document can be correspondingly marked with different marks according to the importance of the paragraph for the electronic document. For example, the most important paragraph of the electronic document can be marked with the highlighted mark, and the secondary paragraph can be marked with the underline mark, and so on. The scope of the present invention is not intended to be limited in this regard. Those skilled in the art can selectively adopt proper mark manner to mark the paragraph of the electronic document according to actual requirement.

Subsequently, the electronic document supplier 219 is operable to receive the marked electronic document from the database 260 and provide the marked electronic document. As a result, end users can download these marked electronic documents from the electronic document supplier 219 through network such that the end users know the importance of each paragraph of the electronic documents when the end users notice the mark, and the goal of making people read information from electronic documents as many as possible in limited time can be achieved.

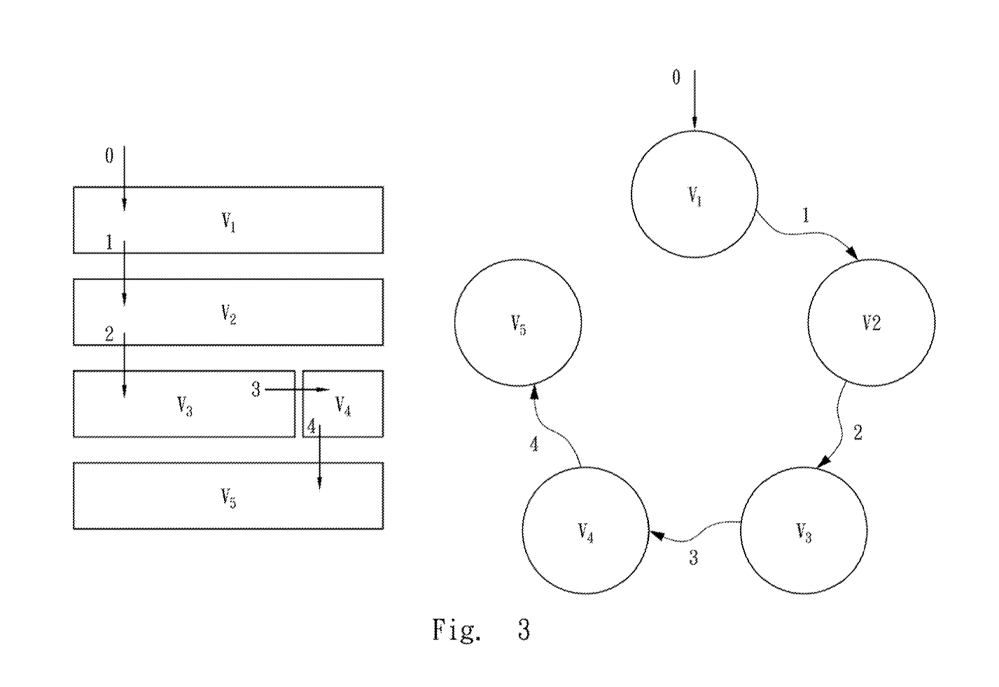

The reading behavior is now described in detailed as below. FIG. 3 schematically shows a diagram of a sequential reading behavior according to embodiments of the present invention. It is noted that the signs V1˜V5 as shown in left hand side of FIG. 3 represent sequence of paragraphs in an electronic document, and arrows and numerals represent reading trajectories and sequence. A vertex connection module of the embodiment of the present invention is shown in the right hand side of FIG. 3, and the vertex connection module is arranged corresponding to the sequence of left hand side of FIG. 3 such that those skilled in the art can understand the present invention easier. As shown in the FIG. 3, it represents a sequential reading, and a user reads paragraphs of the electronic document sequentially.

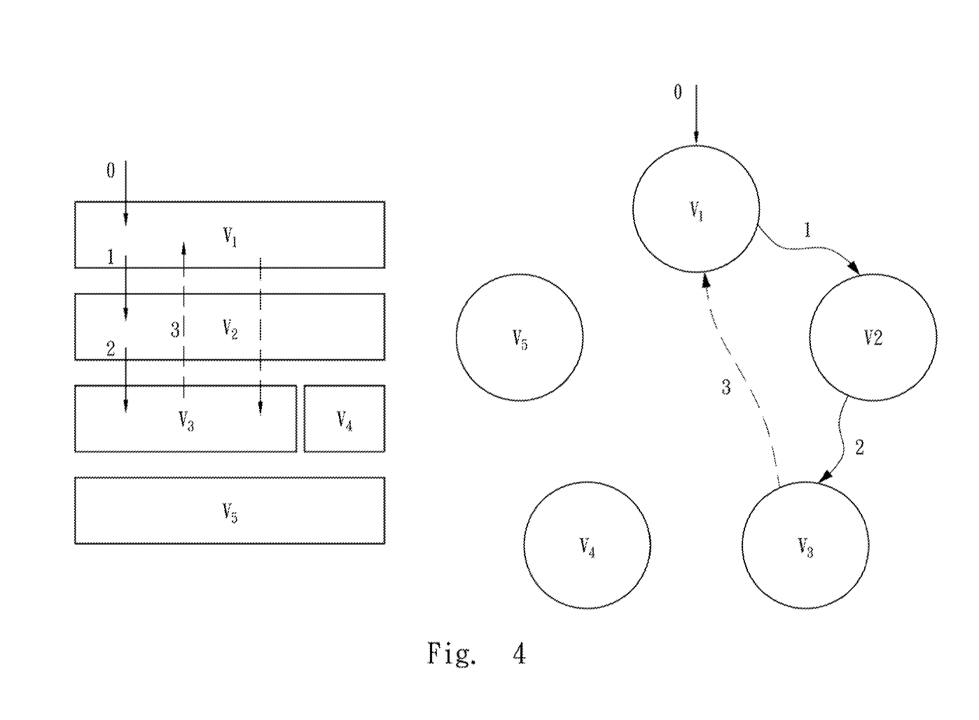

FIG. 4 schematically shows a diagram of a backtracking reading behavior according to embodiments of the present invention. As shown in FIG. 4, after a user reads the third paragraph V3 of the electronic document, the user considers that an important information described in the first paragraph V1 of the electronic document is needed to be recalled, and the user goes back to read the content of the first paragraph V1 of the electronic document. Subsequently, after the user reads the content of the first paragraph V1 of the electronic document, the user continuously reads the rest of third paragraph V3 of the electronic document. As can be seen in left hand side of FIG. 4, the first paragraph V1 of the electronic document is reread by the user twice; and accordingly, the importance of the first paragraph V1 of the electronic document is higher than other paragraphs in FIG. 4.

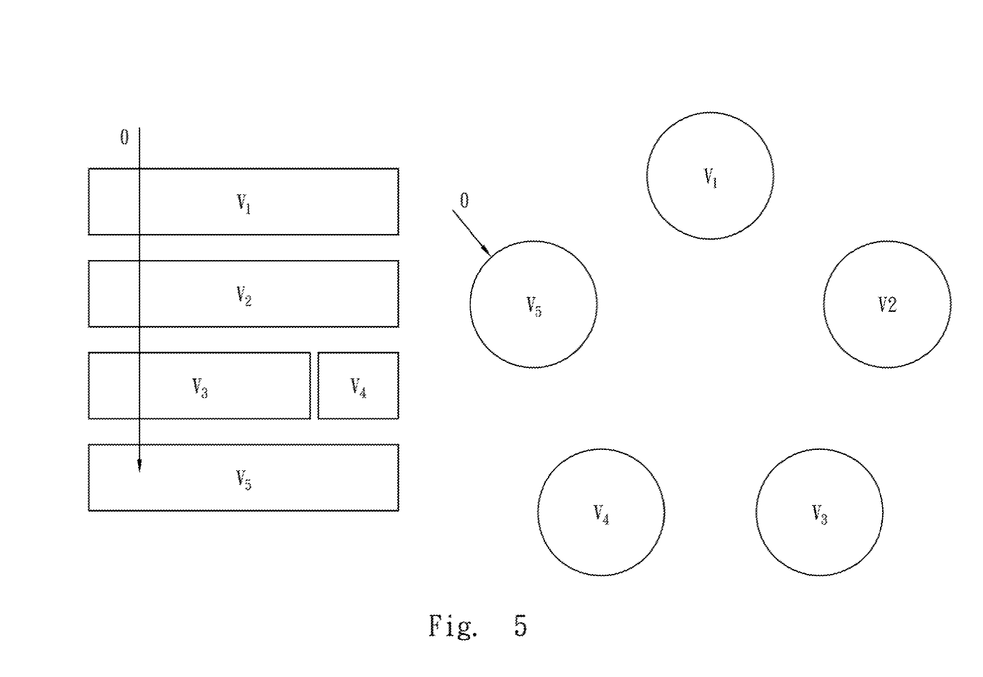

FIG. 5 schematically shows a diagram of a keyword spotting reading behavior according to embodiments of the present invention. As shown in FIG. 5, a user reads the fifth paragraph V5 of the electronic document directly. Accordingly, the importance of the fifth paragraph V5 of the electronic document is higher than other paragraphs in FIG. 5.

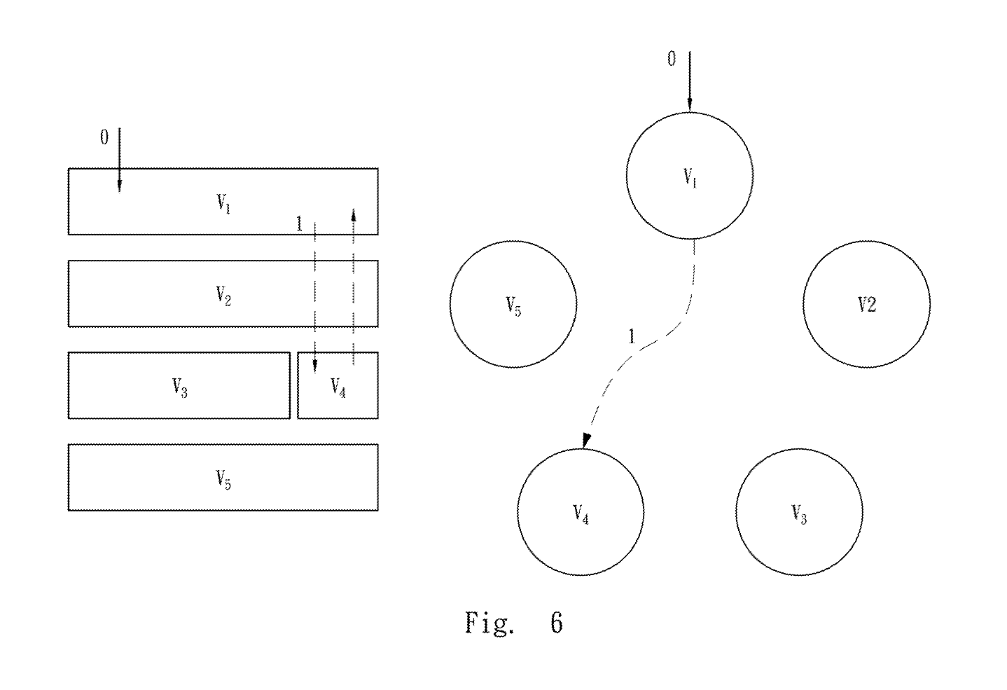

FIG. 6 schematically shows a diagram of a forward checking reading behavior according to embodiments of the present invention. As shown in FIG. 6, after a user reads the first paragraph V1 of the electronic document, the user then reads the fourth paragraph V4 of the electronic document to get prospect information by according to the context of the first paragraph. After getting sufficient prospect information in the fourth paragraph V4, the user then goes back to the first paragraph to continue his/her reading Such a forward checking reading can be modeled as right hand side of FIG. 6, and it makes the importance of the fourth paragraph V4 of the electronic document is higher.

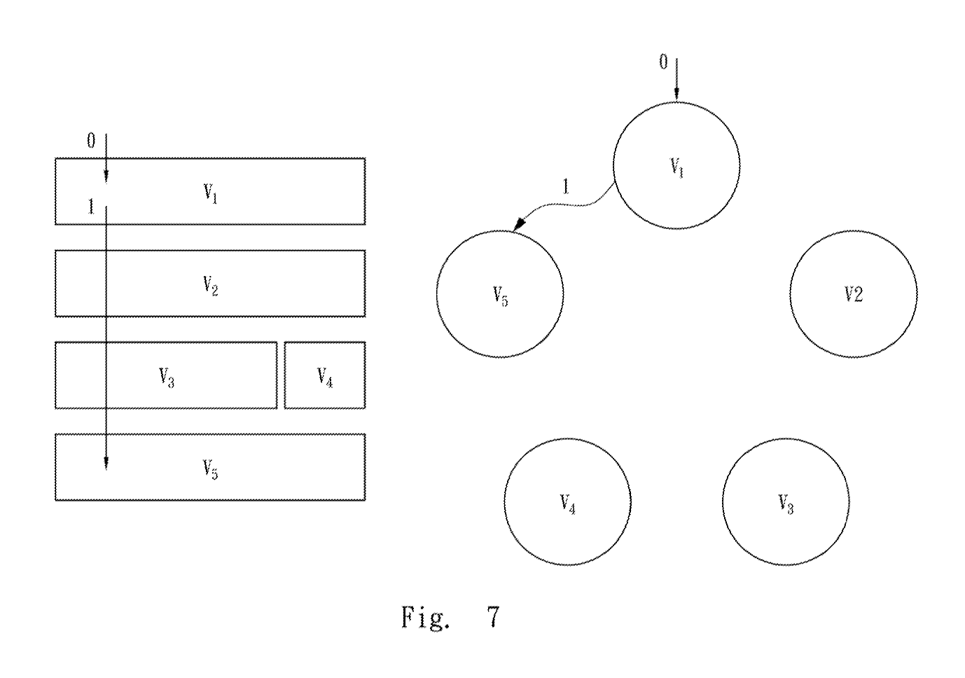

FIG. 7 schematically shows a diagram of a link clicking reading behavior according to embodiments of the present invention. As shown in FIG. 7, after a user reads the first paragraph V1 of the electronic document, the user then reads the fifth paragraph V5 of the electronic document by clicking a link links to the fifth paragraph V5 in the first paragraph V1. Therefore, the importance of the fifth paragraph V5 of the electronic document is higher.

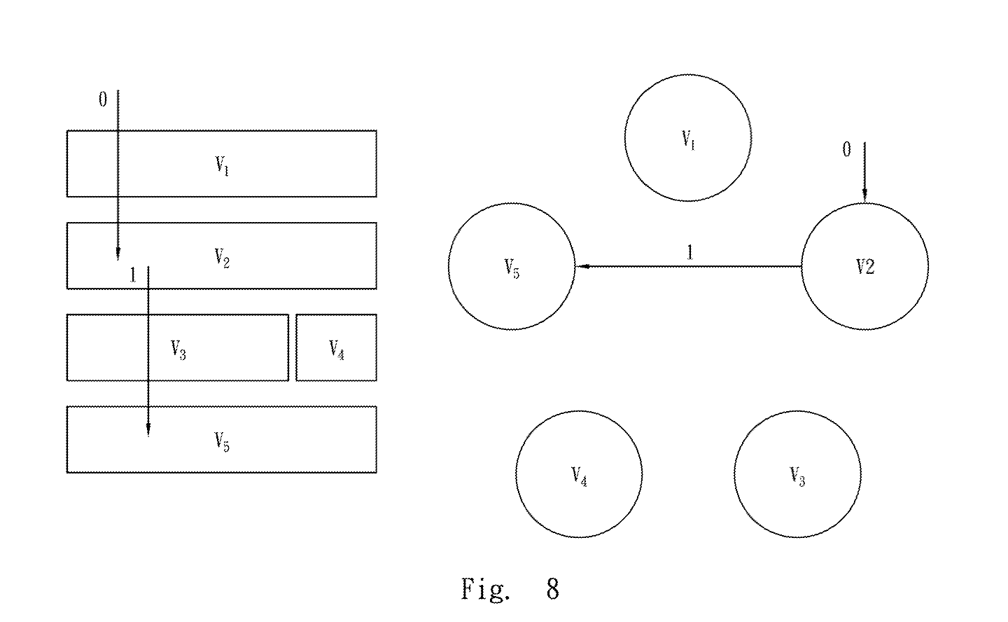

FIG. 8 schematically shows a diagram of a selective reading behavior according to embodiments of the present invention. As shown in FIG. 8, a user reads the second paragraph V2 of the electrical document directly. Subsequently, after the user reads the second paragraph V2 of the electrical document, the user selectively reads the fifth paragraph V5 of the electrical document. Consequently, the importance of the second and fifth paragraphs V2 and V5 are higher. The processor 215 of the embodiment of the present invention can analyze the reading behaviors as shown in FIGS. 3 to 8 to generate reading content weights correspondingly. In addition, the above-mentioned analysis manner can adopt an analysis formula which Google uses to calculate the reading content weights. However, the analysis manner of the present invention is not intended to be limited in the content as shown in FIGS. 3 to 8 and the PageRank analyze formula of Google, and the above-mentioned embodiment is used to merely describe one of implementations of the present invention. The PageRank analyze formula of Google is shown below:

$$PR ( {v}_{i} ) = \frac{1 - d}{\vert V \vert} + d {\sum }_{{v}_{j} ∈ {M}_{j}}^{ } \frac{PR ( {v}_{j} )}{{N}_{j}} ,$$

where PR(vᵢ) represents importance of a paragraph vᵢ, d represents probability of reading based on guidance of a paragraph, 1−d represents probability of reading a paragraph directly, Mᵢ represents a set of paragraph which is pointed at a paragraph of vᵢ, Nⱼ represents number of links at which vᵢ points, |V| represents total number of paragraph in an electronic document.

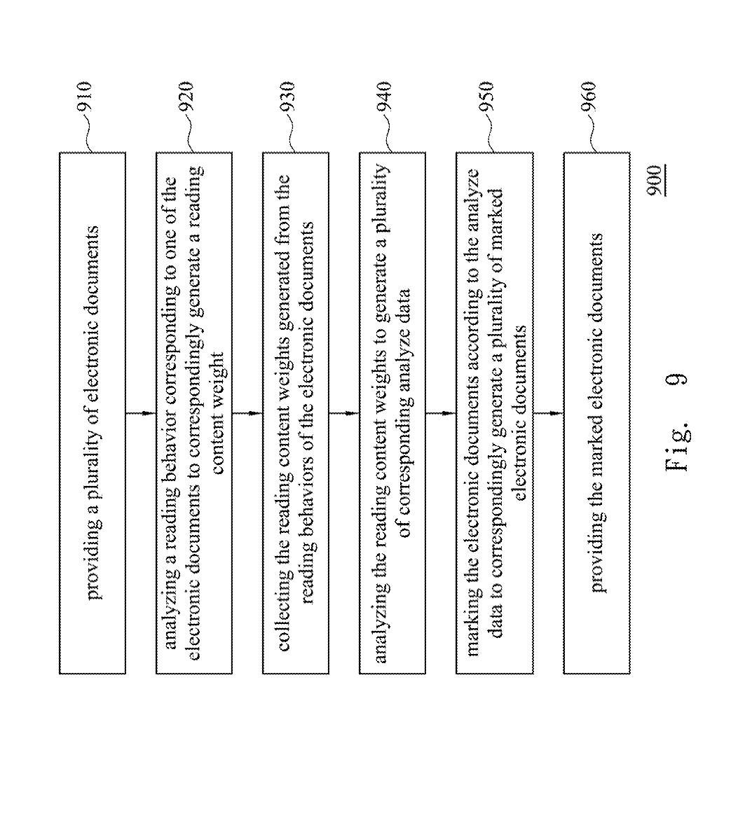

FIG. 9 schematically shows a flow diagram of a method for analyzing reading behavior according to embodiments of the present invention. As shown in FIG. 9, the method 900 for analyzing reading behavior comprises the steps of:

Step 910: provide a plurality of electronic documents;

Step 920: analyzing a reading behavior corresponding to one of the electronic documents to correspondingly generate a reading content weight;

Step 930: collecting the reading content weights generated from the reading behaviors of the electronic documents;

Step 940: analyzing the reading content weights to generate a plurality of corresponding analyze data;

Step 950: marking the electronic documents according to the analyze data to correspondingly generate a plurality of marked electronic documents; and

Step 960: providing the marked electronic documents.

In order to make the above-mentioned steps easier to be understood, reference is now made to both FIGS. 2 and 9. In step 910, the electronic document supplier 219 can be implemented to provide a plurality of electronic documents. Subsequently, in step 920, the processor 215 can be implemented to analyze the reading behavior corresponding to one of the electronic documents to correspondingly generate the reading content weight.

For example, the reading behavior is a reading trajectory which is formed by reading through paragraph to paragraph respectively. The reading trajectory is as shown in FIG. 1. It is noted that a paragraph is used as a unit of the reading behavior. Specifically, the reading trajectory can be a trajectory generated by a sequential reading, a backtracking reading, a keyword spotting reading, a forward checking reading, a link clicking reading, or a selective reading. The reading content weight is corresponding to importance of a paragraph for an electrical document. When the importance of the paragraph for the electrical document is higher, the reading content weight is correspondingly higher. The reading content weight can be generated by the processor 215 is analyzing reading trajectories for electrical documents.

Subsequently, in step 930, the database 260 can be implemented to collect the reading content weights generated from the reading behaviors of the electronic documents. The step of analyzing the reading content weights to generate a plurality of corresponding analyze data can be implemented by the analyzer 259 The processor 255 can be implemented to mark the electronic documents according to the analyze data to correspondingly generate a plurality of marked electronic documents (Step 950).

For example, the database 260 is operable to collect reading content weights of all read electronic documents and transfer the reading content weights to the analyzer 259 for analyzing so as to generate analyze data. The processor 255 can mark the corresponding electronic documents according to the analyze data. Specifically, a mark of the marked electronic document can be a boldface mark, an italic mark, an underline mark, or a highlighted mark. The paragraph of the electronic document can be correspondingly marked with different marks according to the importance of the paragraph for the electronic document. For example, the most importance paragraph of the electronic document can be marked with the highlighted mark, and the secondary paragraph can be marked with the underline mark, and so on. The scope of the present invention is not intended to be limited in this regard. Those skilled in the art can selectively adopt proper mark manner to mark the paragraph of the electronic document according to actual requirement. The analysis manner has been described in the descriptions of FIGS. 3 to 8, and a detailed description regarding the analysis manner is omitted herein for the sake of brevity.

The marked electronic documents can be transferred to the database 260 by the processor 255 for storing. Afterward the electronic document supplier 219 is operable to receive the marked electronic documents from the database 260 and provide these marked electronic documents (step 960).

As a result, with the use of the method 900 for analyzing reading behavior, end users can download the marked electronic documents through the network, and the end users can realize the importance of one of paragraphs of the marked electronic documents by the mark of the marked electronic documents such that people can read information from the electronic documents as many as possible in limited time.

Those having skill in the art will appreciate that the method for analyzing reading behavior can be performed with software, hardware, and/or firmware. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Those skilled in the art will recognize that optical aspects of implementations will typically employ optically oriented hardware, software, and or firmware.

In addition, those skilled in the art will appreciate that each of the steps of the method for analyzing reading behavior named after the function thereof is merely used to describe the technology in the embodiment of the present invention in detail but not limited to. Therefore, combining the steps of said method into one step, dividing the steps into several steps, or rearranging the order of the steps is within the scope of the embodiment in the present invention.

In view of the foregoing embodiments of the present invention, many advantages of the present invention are now apparent. The embodiment of the present invention provides an electronic document supplying system and a method for analyzing reading behavior, which is used to mark electronic documents according to reading behaviors such that people can read information from the electronic documents as many as possible in limited time.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

What is claimed is:

1. An electronic document supplying system, comprising:
a host server device, comprising:
an electronic document supplier being operable to provide a plurality of electronic documents; and
a first processer being operable to analyze a reading behavior corresponding to one of the electronic documents to correspondingly generate a reading content weight, wherein the first processer is to operable to transfer the reading content weight to the electronic document supplier; and
an analysis server device, comprising:
a database being operable to collect the reading content weights generated from the reading behaviors of the electronic documents;
an analyzer being operable to analyze the reading content weights to generate a plurality of corresponding analyze data; and
a second processer being operable to mark the electronic documents according to the analyze data to correspondingly generate a plurality of marked electronic documents and transfer the marked electronic documents to the database for storing;
wherein the electronic document supplier is operable to receive the marked electronic documents from the database to provide the marked electronic documents.

2. The electronic document supplying system according to claim 1, wherein a paragraph is used as a unit of the reading behavior.

3. The electronic document supplying system according to claim 2, wherein the reading behavior is a reading trajectory which is formed by reading through paragraph to paragraph respectively.

4. The electronic document supplying system according to claim 2, wherein the reading behavior comprises one of a group consisting of a sequential reading, a backtracking reading, a keyword spotting reading, a forward checking reading, a link clicking reading, and a selective reading.

5. The electronic document supplying system according to claim 1, wherein a mark of the marked electronic document comprises one of a group of a boldface mark, an italic mark, an underline mark, and a highlighted mark.

6. A method for analyzing reading behavior, comprising:
providing a plurality of electronic documents;
analyzing a reading behavior corresponding to one of the electronic documents to correspondingly generate a reading content weight;
collecting the reading content weights generated from the reading behaviors of the electronic documents;
analyzing the reading content weights to generate a plurality of corresponding analyze data;
marking the electronic documents according to the analyze data to correspondingly generate a plurality of marked electronic documents; and
providing the marked electronic documents.

7. The method for analyzing reading behavior according to claim 6, wherein a paragraph is used as a unit of the reading behavior.

8. The method for analyzing reading behavior according to claim 7 wherein the reading behavior comprises:
reading through paragraph to paragraph respectively.

9. The method for analyzing reading behavior according to claim 7, wherein the reading behavior comprises one of a group consisting of a sequential reading, a backtracking reading, a keyword spotting reading, a forward checking reading, a link clicking reading, and a selective reading.

10. The method for analyzing reading behavior according to claim 6, wherein a mark of the marked electronic document comprises one of a group of a boldface mark, an italic mark, a underline mark, and a highlighted mark.
